(19) United States
(12) Patent Application Publication
(10) Pub. No.: US 2016/0327798 A1
(43) Pub. Date: Nov. 10, 2016

(54) AUGMENTED REALITY (AR) SYSTEM

(71) Applicants: Zhen XIAO, Beijing (CN); EMPIRE TECHNOLOGY DEVELOPMENT LLC, Wilmington, DE (US)

(72) Inventor: Zhen XIAO, Beijing (CN)

(73) Assignee: Empire Technology Development LLC, Wilmington, DE (US)

(21) Appl. No.: 15/109,568

(22) PCT Filed: Jan. 2, 2014
(86) PCT No.: PCT/CN2014/070019

§ 371 Date: Jul. 1, 2016

(51) Int. Cl. G02B 27/01; G06T 19/00; G02B 27/00

(52) U.S. Cl. CPC G02B 27/0179; G02B 27/0172; G02B 27/0093; G06T 19/006; G02B 2027/0187; G02B 2027/0138; G02B 2027/014

(57) ABSTRACT

In an AR system, an AR display device may be configured to generate a virtual image that includes information provided by a computer device next to or overlaying a physical object that is observed by a user utilizing the AR system in real time.

### TECHNICAL FIELD

The embodiments described herein pertain generally to providing information on the basis of a real time observation of reality in an augmented reality (AR) system.

### BACKGROUND

Unless otherwise indicated herein, the approaches described in this section are not prior art to the claims in this application and are not admitted to be prior art by inclusion in this section.

In an augmented reality (AR) system, information, e.g., virtual images, may be provided based on a real time visual observation of reality that may be captured by a camera, a human eye, etc. The additional information may be generated to overlay multiple objects included in the real time observation of reality.

### SUMMARY

Technologies are generally described for providing additional information on the basis of a real time observation of reality in an AR system. The various techniques may be implemented in various devices, methods and/or systems.

In some examples, various techniques may be implemented as systems. Some example systems may include one or more pixel structures. In some examples, each pixel structure comprises one or more object side micro lenses each respectively disposed on an object side of a corresponding one of the one or more pixel structures; and one or more distal side micro lenses, each of which is disposed on a distal side of the corresponding pixel structure, and each of which is configured to restore, with the object side micro lenses, first light beams that are sourced from a physical object and which pass through the pixel structure. A system may further be configured to produce a virtual image layer with a display of content provided by an external data resource. Each pixel structure may comprise one or more light emission units, and the virtual image layer may be formed with light emitted from selected (and thereby activated) light emission units. A plurality of pixel structures may be arranged in an array, for example a one- or two-dimensional array.

In some examples, various techniques may be implemented as methods. Some methods may include producing, by the distal side micro lens together with the object side micro lens, first light beams that are emitted or reflected from the physical object, and producing, by the distal side micro lens and at least the pixel, a virtual image layer with a display of content provided by an external data source.

In some examples, various techniques may be implemented as a computer-readable medium. In some examples, a computer-readable medium stores a data structure which may include executable instructions for selecting, via the computer device, at least one light emission unit of the pixel to emit light; generating second light beams using the light emitted from the at least one light emission unit selected; generating a virtual image layer utilizing the second light beams, wherein the virtual image layer overlays at least one image of a physical object with a display of content provided by an external data source. The data structure may be non-transitory.

The foregoing summary is illustrative only and is not intended to be in any way limiting, in addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications may be made in view of the following detailed description. The use of the same reference numbers in different figures indicates similar or identical items. In the drawings:

FIG. 1 shows an example environment in which one or more embodiments of an AR system may be implemented;

FIG. 2 shows an example configuration of AR display device by which one or more embodiments of the example AR system may be implemented;

FIG. 3 shows an example pixel unit by which one or more embodiments of the example AR system may be implemented;

FIG. 4 shows an example portion of the AR display device by which one or more embodiments of the example AR system may be implemented;

FIG. 5 shows an example configuration of a processing flow of operations by which the AR system may be implemented; and

FIG. 6 shows a block diagram illustrating an example computer device by which various example solutions described herein may be implemented;

all arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. The aspects of the present disclosure, as generally described herein and illustrated in the drawings, may be arranged, substituted, combined, separated, and designed in a wide variety of different configurations, all of which are explicitly contemplated herein.

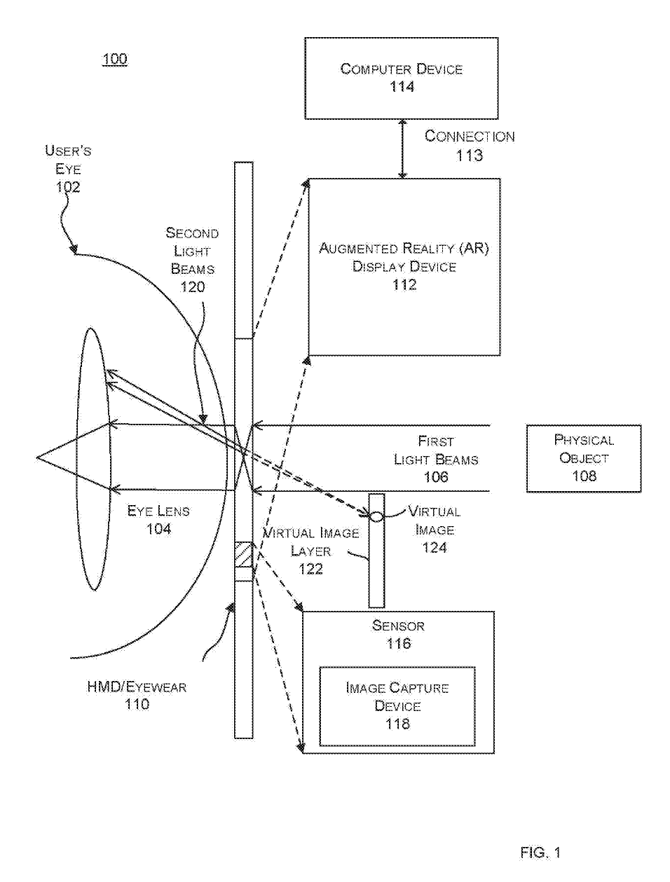

FIG. 1 shows an example environment 100 in which one or more embodiments of an example AR system may be implemented, in accordance with at least some embodiments described herein. As depicted, example environment 100 may include at least a user's eye 102 that includes an eye lens 104; multiple first light beams 106; a physical object 108; and a head mounted device (HMD)/eyewear 110 that includes an AR display device 112 connected, via a connection 113, to a computer device 114, a sensor 116, and an image capture device 118, and multiple second light beams 120 that create a virtual image layer 122, which may include a virtual image 124.

User's eye 102 may refer to an organ that may collect and focus light through eye lens 104 to form an image on a retina (not shown). Light may also be partially focused by the cornea, but for illustrative simplicity this is not shown in the figure.

Eye lens 104 may refer to a transparent and biconvex crystalline lens in user's eye 102 that may refract light to be focused on the retina. It may be assumed and understood that the formed image may be further converted into a set of electrical signals and transmitted to a user's brain.

First light beams 106 may refer to multiple light beams that originate from physical object 108 and are directed towards user's eye 102, for example light beams that may be emitted or reflected from the physical object 108.

Physical object 108 may refer to a visible object that may emit light, e.g., a lamp, a lit candle, etc., or reflect first light beams 106. First light beams may travel from physical object 108 through HMD/eyewear 104 to user's eye 102, and be focused by eye lens 104.

HMD/eyewear 110 may refer to a physical device that may be removably mounted on the user's head at a relatively fixed distance to eye 102. Non-limiting examples of HMD/eyewear 110 may include, sunglasses, prescription glasses, goggles, etc. HMD/eyewear 110 may include one or more components including AR display device 112, sensor 116, and image capture device 118.

AR display device 112, which may include sensor 116 and image capture device 118, may refer to a physical component that may be configured to allow first light beams 106, which originate from physical object 108, to pass through and further emit second light beams 120 to generate virtual image 124 on virtual image layer 122. Further, AR display device 112 may be communicatively coupled to computer device 114, via connection 113.

Connection 113 may refer to a communication link capable of transferring data between two devices, e.g., image capture device 118 and computer device 114. In some examples, connection 113 may follow one of multiple communication protocols, e.g., Bluetooth, wireless fidelity (“Wi-Fi”), WiMAX, Near Field Communication (NFC), etc.

Computer device 114 may refer to a physical device that may be configured to generate visual contents for AR display device 112 and process raw data that may be collected by sensor 116 and image capture device 118. In some examples, computer device 114 may be configured to provide information pertaining to virtual image 124, e.g., identity information of a person, historical background of a famous landmark, a virtual chessboard on a table, turn-by-turn navigation instructions, etc.

Sensor 116 may refer to a physical component of AR display device 112 that may be configured to detect a focal distance of user's eye 102 since the focal distance of human eyes may change when people are viewing objects at different distances. The detected focal distance may be transmitted to computer device 114, via connection 113. Computer device 114 may be configured to adjust AR display device 112, based on the detected focal distance, to change the position of virtual image layer 122 so that virtual image 124 may or may not overlay physical object 108.

Image capture device 118 may refer to a physical component of AR display device 112 that may be configured to capture at least one digital image that includes physical object 108 and the background thereof, and transmit the data of, e.g., physical object 108 in the captured images to computer device 114. In accordance with some existing image recognition algorithms, computer device 114 may recognize physical object 108 from the captured image and, further, provide corresponding content of virtual image 124 for AR display device 112 to display. For example, when physical object 108 is a human face, computer device 114 may be configured to execute one or more facial recognition algorithms and to determine the identity of the person. The identity information of the person may then be transmitted to AR display device 112 and displayed at virtual image layer 122 next to the face. That is, the identity information of the person may appear adjacent to physical object 108, e.g., a face, as seen through AR display device 112.

Second light beams 120 may refer to light beams that are emitted from AR display device 112, portions of which are emitted towards user's eye 102. Similar to first light beams 106, second light beams 120 may be received by user's eye 102 and refracted by eye lens 104 to project an image on the user's retina. The direction of second light beams may be adjustable by AR display device 112 so that the position of virtual image layer 122 may be accordingly adjusted.

Virtual image layer 122 may refer to a spatial layer corresponding to an intersection point of reverse extension lines of second light beams 120. In some examples, the apparent location of virtual image layer 122 may be configured, by AR display device 112, to overlay physical object 108, e.g., a virtual chessboard on a table. In yet other examples, virtual image layer 122 may be displayed next to physical object 108, e.g., identity information appears adjacent to a face, body, or object, as seen through AR display device 112.

Virtual image 124 may refer to a digital image, or a series of digital images, generated in virtual image layer 122 by AR display device 112. Virtual image 124 may be generated in the form of texts, pictures, video clips, etc. As mentioned above, non-limiting examples of the content of virtual image 124 may include identity information of a person, historical background of a famous landmark, a virtual chessboard on a table, turn-by-turn navigation instructions, etc.

Thus, example environment 100 may include at least user's eye 102 that includes eye lens 104 and multiple first light beams 106 emitted from physical object 108 towards head mounted device (HMD)/eyewear 110 that includes AR display device 112 connected, via a connection 113, to computer device 114. AR display device 112 may include sensor 116 and an image capture device 118. Multiple second light beams 120 that create virtual image layer 122, which may include virtual image 124, may be emitted from AR display device 112.

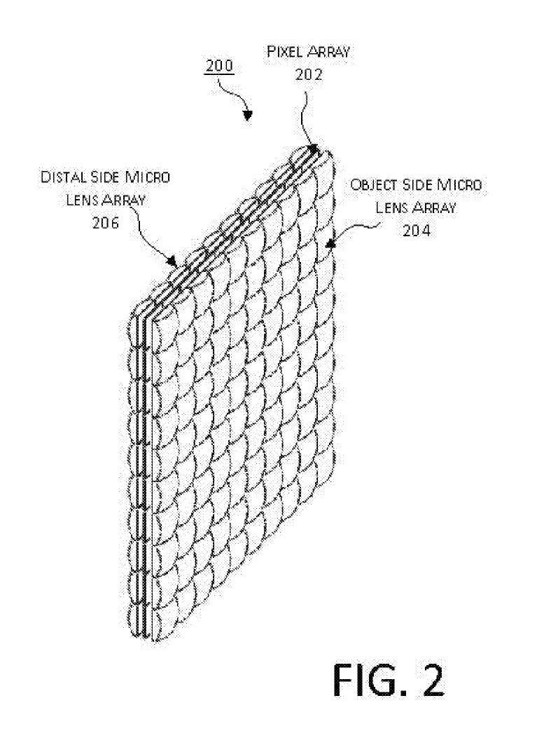

FIG. 2 shows an example configuration 200 of AR display device 112 by which one or more embodiments of the example AR system may be implemented, in accordance with at least some embodiments described herein. As depicted, example configuration 200 may include at least a pixel array 202, an object side micro lens array 204 disposed on the object side of pixel array 202, and a distal side micro lens array 206 disposed on the distal side of pixel array 20. As referenced herein, distal side may refer to the side of AR display device 112 on which user's eye 102 is located, and object side may refer to the side of AR display device 112 on which physical object 108 is positioned.

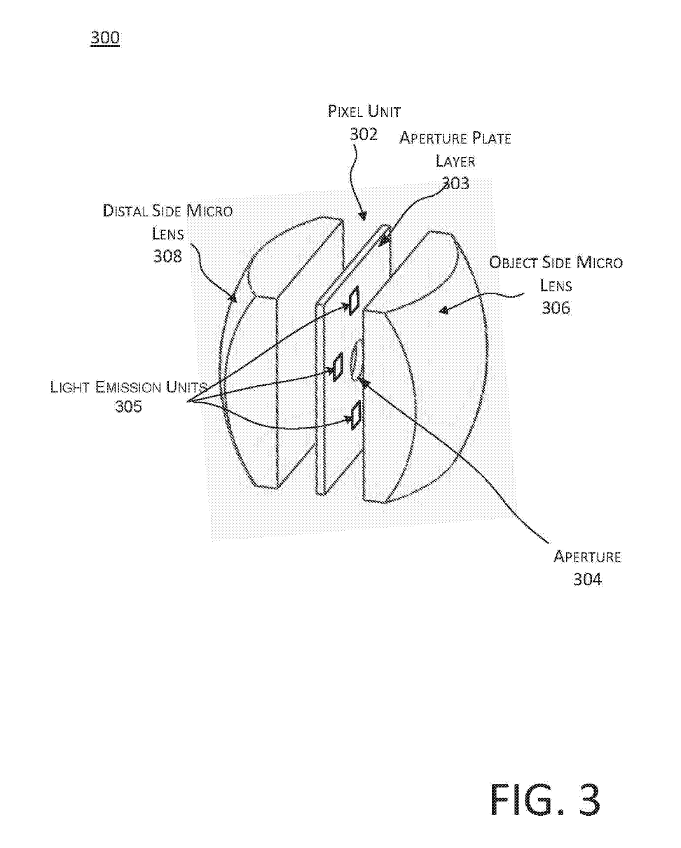

Pixel array 202 may refer to a physical layer of AR display device 112, which may include multiple pixels that may be configured to allow first light beams 106 to pass through and to emit second light beams 120. Each of the multiple pixels may refer to an addressable element of AR display device 112. The structure of each pixel is described in greater detail in accordance with FIG. 3.

Object side micro lens array 204 may refer to a physical layer of optical components disposed on the object side of AR display device 112, which may include multiple object side micro lenses to converge first light beams 106 to pass through pixel array 202. Each object side micro lens may refer to a convex lens.

Distal side micro lens array 206 may refer to a physical layer of optical components disposed on the distal side of AR display device 112, which may include multiple distal side micro lenses to converge the converged first light beams 106 that passed through pixel array 202 so that user's eye 102 may see physical object 108 as if AR display device did not exist. Each distal side micro lens may refer to a crystalline convex lens.

Thus, example configuration 200 of AR display device 112 may include pixel array 202 that allows first light beams 106 to pass through and to emit second light beams 112, object side micro lens array 204 to converge first light beams 106, and distal side micro lens array 206 to converge the converged first light beams 106.

FIG. 3 shows an example pixel structure 300 by which one or more embodiments of the example AR system may be implemented, in accordance with at least some embodiments described herein. As depicted, example pixel structure 300 may, at least, include a pixel unit 302 with an aperture plate layer 303 and one or more light emission units 305 disposed thereon, an object side micro lens 306, and a distal side micro lens 308. An aperture 304 may be opened at aperture plate layer 303. The aperture may be in the form of a pinhole. The aperture may have a diameter in the range 1 micron-1 mm, for example in the range 5 microns-500 microns, in particular 10 microns-100 microns, or other ranges. In some examples, ranges are approximate. In some examples, ranges are inclusive. Example ranges are not limiting.

Pixel unit 302 may refer to a physical component that includes aperture plate layer 303 and light emission units 305.

Aperture plate layer 303 may refer to a substrate upon which the multiple light emission units are disposed. Aperture 304 may refer to an opening in a central region of aperture plate layer 303 configured to allow light beams to pass through.

Light emission units 305 may be disposed at different positions on aperture plate layer 303 and may be configured to emit second light beams 120. In some examples, light emission units 305 may be controllable by computer device 114. That is, computer device 114 may be configured to activate or deactivate a subset of light emission units 305 and to adjust the intensity of the subset of light emission units 305 to reach a particular degree of illumination to match the brightness of the environment. Non-limiting examples of light emission units 305 may include light emission diode (LED), organic light emission diode (OLED), etc.

Object side micro lens 306 may refer to a convex lens that may be configured to converge first light beams 106 to pass through aperture 304.

Distal side micro lens 308 may refer to a convex lens that may be configured to converge the converged first light beams 106 that passed through aperture 304.

Thus, example pixel unit 300 may include at least object side micro lens 306 to converge first light beams 106 to pass through aperture 304 disposed on aperture plate layer 303 of pixel 302, distal side micro lens 308 to converge the converged first light beam 106, and light emission units 305 to create second light beams 120 to be refracted by distal side micro lens 308.

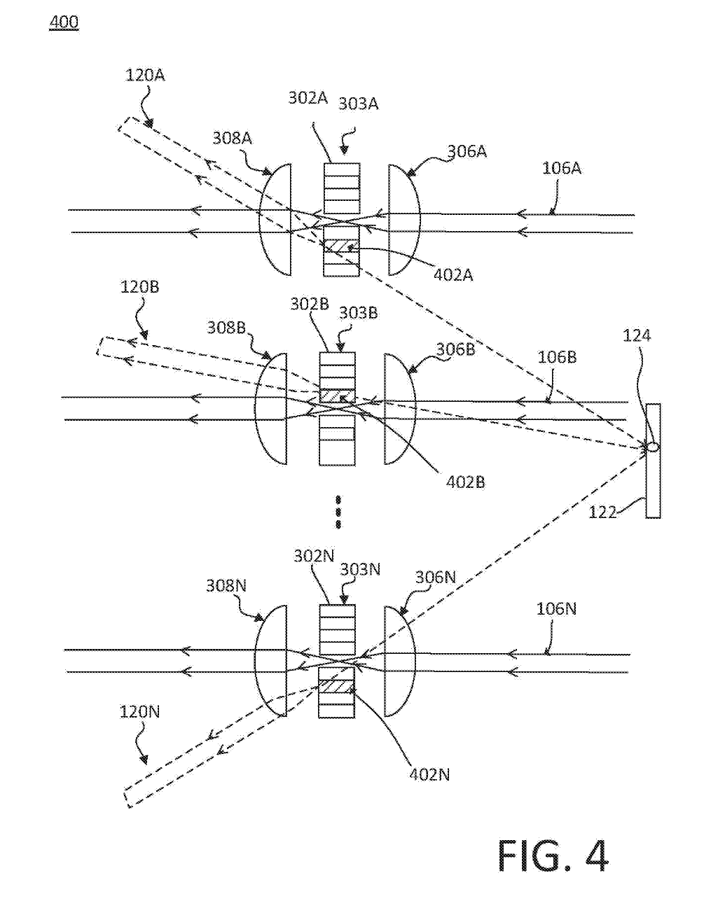

FIG. 4 shows an example portion 400 of the AR display device 112 by which one or more embodiments of the example AR system may be implemented, in accordance with at least some embodiments described herein. As depicted, example portion 400 may include at least multiple embodiments of example pixel unit 300, each of which respectively includes one of multiple pixels 302A-302N, one of multiple aperture plate layers 303A-303N, one of multiple object side micro lenses 306A-306N, and one of multiple distal side micro lenses 308A-308N. Each of multiple aperture plate layers 303A-303N may include a respective one of multiple activated light emission units 402A-402N. Such depiction is provided as a non-limiting example that is not so restricted with regard to quantity.

Activated light emission units 402A-402N may each refer to a light emission unit that is activated by computer device 114 to emit a respective portion of second light beams 120A-120N. Each of activated light emission units 402A-402N may be disposed at a different position relative to a respective one of aperture plate layers 303A-303N so that the position of virtual image layer 122 may be adjustable by computer device 114. That is, by selecting different ones of light emission units 305 at different positions to activate, computer device 114 may be configured to essentially control the directions of each portion of second light beams 120 and, further, to adjust the position of virtual image layer 122. The selecting may be performed in accordance with the focal distance detected by sensor 116.

First light beams 106A-106N may be emitted or reflected from physical object 108 onto one or more of object side micro lenses 306A-306N, and may then be refracted, or converged, to pass through the apertures at respective ones of aperture plate layers 303A-303N. The refracted, or converged, first light beams 106A-106N may be refracted by one or more of distal side micro lenses 308A-308N onto the original optical path of first light beams 106A-106N so that user's eye 102 may be able to see physical object 108 through AR display device 112.

Activated light emission units 402A-402N, which correspond respectively to each of aperture plate layers 303A-303N, may be activated by computer device 114 to emit second light beams 120A-120N, each of which may be emitted in different directions. When second light beams 120A-120N reach eye lens 104, virtual image 124 may be perceived by eye 102 at virtual image layer 122. That is, virtual image 124, which may be visible to user's eye 102, is created at the reverse extension lines of second light beams 120A-120N. In some examples, the direction of second light beams may be steered using a signal, for example an electrical signal provided by the AR device and received by a light emission device or optical element associated with the light emission device. For example, an dynamically controllable lens (e.g. with electrically controlled curvature and/or refractive index) or other electrooptical element (such as a liquid crystal element) may be used to steer a second beam along a desired direction, for example to generate (e.g. with other second beams) a desired virtual image layer position relative to objects in the environment. A beam steering device, such as a dynamically controllable lens, may be integrated into a light emission unit or otherwise associated with the light emission unit.

FIG. S shows an example configuration of a processing flow of operations by which the AR system may be implemented, in accordance with at least some embodiments described herein. As depicted, processing flow 500 includes sub-processes executable by various components (including one or more processors or other hardware element) that are part of environment 100. However, processing flow 500 is not limited to such components, and modification may be made by re-ordering two or more of the sub-processes described here, eliminating at least one of the sub-processes, adding further sub-processes, substituting components, having various components assuming sub-processing roles accorded to other components in the following description, and/or combinations thereof. Processing flow 500 may include various operations, functions, or actions as illustrated by one or more of blocks 502, 504, and/or 506. Processing may begin at block 502.

Block 502 (Select Light emission Units) may refer to computer device 114 selecting at least one of the light emission units 402A-402N disposed on aperture plate layer 303, and activating the selected light emission units. Computer device 114 may select and activate particular ones of light emission units 402A-402N to generate and emit second light beams 120 in different directions. Processing may continue from block 502 to block 504.

Block 504 (Generate Virtual Image) may refer to AR display device 112 generating virtual image layer 122 by utilizing second light beams 120. That is, virtual image layer 122 may be produced at a spatial position corresponding to the intersection point of reverse extension lines of second light beams 120. Since computer device 114 may control the direction of second light beams 120 by selecting particular ones of light emission units 402A-402N at different positions, computer device 114 may be able to consequentially control the spatial position of virtual image layer 122 in accordance with a focal distance detected by sensor 116. As a result, in some examples, virtual image layer 122 may be configured, by AR display device 112, to overlay physical object 108, e.g., a virtual chessboard on a table. In yet other examples, virtual image layer 122 may be configured to be next to physical object 108, e.g., identity information of a human face. Processing may continue from block 502 to block 504.

Block 506 (Adjust Status) may refer to computer device 114 adjusting the status of the activated ones of light emission units 402A-402N to match the brightness of the environment. In some examples, multiple parameters of the light emission units may be controllable by computer device 114. The parameters may include the color, the luminance, etc. Block 506 may further include sub-processes indicated by block 508, block 510, and block 512.

Block 508 (Control Illumination) may refer to computer device 114 controlling a degree of illumination of the activated ones of light emission units 402A-402N. The degree of illumination may be determined by computer device 114 in accordance with the brightness of surrounding environment, which may be detected by a light sensor affixed to AR display device 112. For example, in a relatively dark environment, the illumination may be maintained below a level to ensure that eye 102 may be able to see physical object 108 in the dark environment when the pupil of user's eye 102 is constricted due to the irritation of the illumination of the activated light emission units. Processing may continue from block 508 to block 510.

Block 510 (Adjust Intensity) may refer to computer device 114 adjusting an intensity of second light beams 120 based on the determined degree of illumination. That is, computer device 114 may be configured to increase or reduce the number of the activated light emission units 402A-402N or to change the luminance of ones thereof so that the intensity of second light beams may be modified in accordance with the determined degree of illumination. Processing may continue from block 510 to block 512.

Block 512 (Fuse Virtual Image Layer) may refer to computer device 114 fusing virtual image layer 122 with physical object 108. As described above, virtual image layer 122 may be positioned overlaying or next to physical object 108 so that the information provided in virtual image 124 may make sense to a user.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

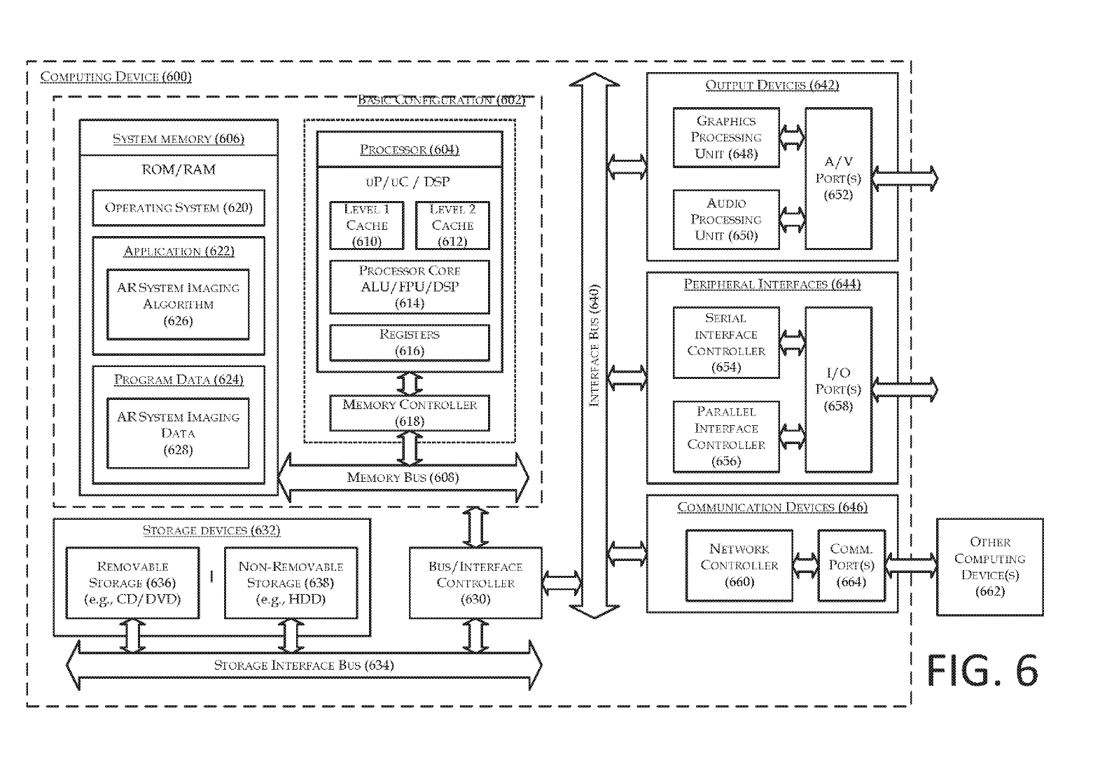

FIG. 6 shows a block diagram illustrating an example computer device by which various example solutions described herein may be implemented, in accordance with at least some embodiments described herein.

In a very basic configuration 602, computer device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

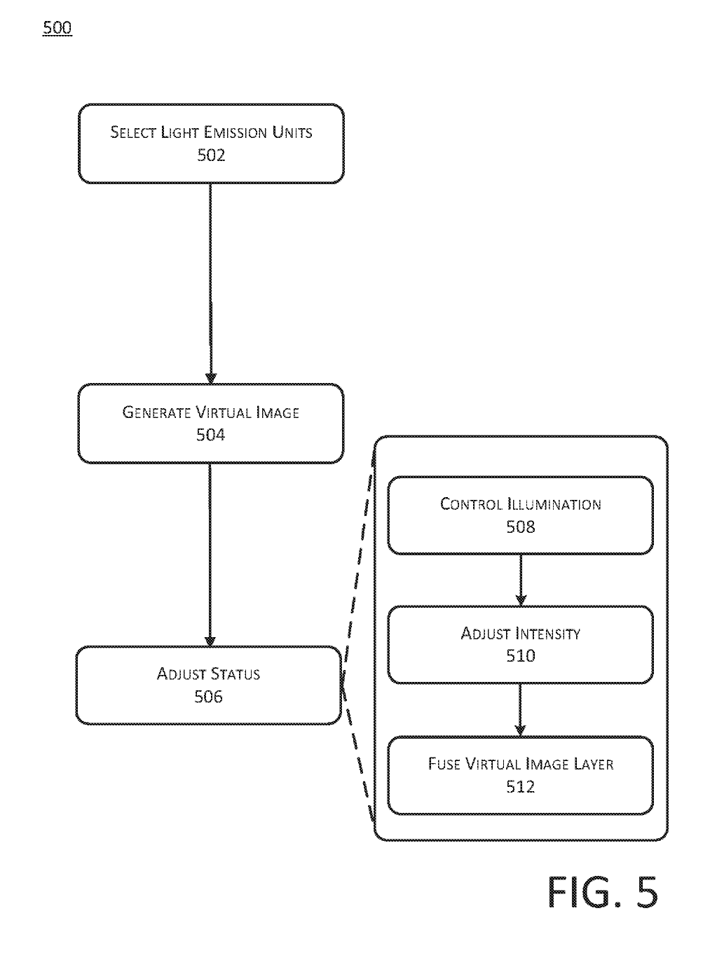

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include an AR system imaging algorithm 626 that is arranged to perform the functions as describe herein including those described with respect to process 500 of FIG. 5. Program data 624 may include AR system imaging data 628 that may be useful for operation with AR system imaging algorithm 626 as is described herein. In some embodiments, application 622 may be arranged to operate with program data 624 on operating system 620 such that implementations of AR system imaging may be provided as described herein. This described basic configuration 602 is illustrated in FIG. 6 by those components within the inner dashed line.

Computer device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computer device 600. Any such computer storage media may be part of computer device 600.

Computer device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.)via one or more I/O ports 658. An example communication device 646 includes a network controller 660, which may be arranged to facilitate communications with one or more other computer devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computer device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computer device 600 may also be implemented as a personal computer including both laptop computer and non-laptop computer configurations. In some examples, an augmented reality (AR) display system may include a computer device.

In some examples, an augmented reality (AR) display system comprises a plurality of pixel structures. Each pixel structure may comprise an object side micro lens disposed on an object side of the pixel structure, a distal side micro lens disposed on a distal side of the pixel structure, and an aperture plate layer configured to define an aperture. The aperture is located between the object side micro lens and the distal side micro lens, the lenses and aperture being configured so that light from objects in the environment (and incident on the object side) is converged by the object side micro lens, passes through the aperture, and then passes through the distal side micro lens. In some examples, the incident light is first converged by the object side micro lens, and then substantially restored to its original direction by the distal side micro lens.

In some examples, the AR device comprises an object side micro lens array, a distal side micro lens array, and an aperture plate layer defining an array of apertures located between the distal side and object side lens arrays. In some examples, a focus of each micro lens of the object side micro lens array is coincident (or at least approximately coincident) with a focus of each micro lens of the distal side micro lens array. In some examples, an aperture is located between a pair of micro lenses so that the aperture is located at (or proximate) the focus of each lens. In some examples, a AR display system includes a plurality of pixel structures, at least one pixel structure comprising an object side micro lens, a distal side micro lens, and an aperture, configured so that a light beam incident on the object side micro lens emerges from the distal side micro lens, in some examples along a substantially parallel direction to the incident direction.

In some examples, each pixel structure may be configured so that a light beam incident on the object side micro lens then passes through the object side micro lens, the aperture, and the distal side micro lens, in that order. In some examples, the object side micro lens and the distal side micro lens have approximately the same focal length and dimensions, and may form a matched micro lens pair. In some examples, an aperture may be located between the matched micro lens pair, and approximately equidistant from both. In some examples, an object side and a distal side lens are arranged so that the optical axis of each lens is parallel to and in registration with the other, and an imaginary line extending between the optical axis of each lens may pass through the aperture. In some examples, the micro lenses comprise glass, optical plastic, and the like, and may be substantially transparent to light or tinted as desired, for example in an application as augmented sunglasses. In some examples, the object side micro lens (and/or the distal side micro lens) is a converging lens, such as a convex lens, such as a plano-convex lens. In some examples, the planar sides of a pair of planar-convex micro lenses (comprising a distal and an object side micro lens) are arranged so that the planar sides face each other, with the aperture located between the planar sides of the micro lenses.

In some examples, by concentrating incident light at a plurality of apertures, and then restoring the incident light to approximately its original state, the light blocking effect of the light emission units and aperture plate layer is considerably reduced. A plurality of light emission units may then produce light that is combined with the incident light, for example to create an augmented representation of the environment. Each pixel structure may include one or more light emission units, for example with a plurality of color emissions, such as red, green, and blue light emission units. Light emission units may be electroluminescent devices, such as light emission diodes (LEDs), organic light emission diodes (OLEDs), and the like.

In some examples, an augmented reality (AR) display system comprises a first array of micro lenses, a second array of micro lenses, an aperture plate layer defining an array of apertures, wherein the aperture plate layer is located between the first array of micro lenses and the second array of micro lenses, and light emission units located between the first array of micro lenses and the second array of micro lenses. A controller may be configured to select and illuminate selected light emission units based on received content data. Light incident on the first array of micro lenses (incident light) passes through the array of apertures and then through the second array of micro lenses, and illumination from the selected light emission units passes through the second array of micro lenses without passing through the array of apertures. The illumination from the selected light emission units may then be combined with the incident light to form an augmented reality. The incident light shows a real representation of the environment, whereas the illumination from the selected light emission units may be used to form a virtual image. In this context, “virtual” may refer to perceived image elements that are not actually present in the environment.

In some examples, a pixel structure may comprise a pixel unit, and the pixel unit may be located between the object side micro lens and the distal side micro lens. The pixel unit may include an aperture plate layer defining an aperture, and one or more light emission units supported by the aperture plate layer. In some examples, the light emission units are configured to produce illumination that passes through the distal side micro lenses. In some examples, substantially all illumination from the light emission units emerging from the system passes through the distal side micro lenses.

In some examples, one or more light emission units of each pixel structure are supported by the aperture plate layer. In some examples, each pixel structure may include an aperture plate layer provided by a discrete element. In some examples, the aperture plate layer for each pixel structure is provided as a portion of a larger aperture plate layer. In some examples, a single aperture plate layer defining a plurality of apertures effectively provides the aperture plate layer for each of a plurality of pixel structures.

In some examples, an AR system is configured to produce a virtual image layer using the light emission units. The system may be configured to select one or more of the light emission units, associated with one or more pixel structures. Selected light emission units produce light which may then appear to originate from a virtual plane (when viewed from the distal side). In some examples, virtual images may all appear to be on the same virtual plane. In some examples, virtual images may appear on various virtual planes, for example to correspond to the apparent depth of objects within the environment.

In some examples, a virtual image layer is produced using light emission units and distal side micro lenses. The perceived position of the virtual image layer, as viewed by a user located on the distal side, may depend on the configuration of the light emission units and the distal side micro lenses. In some examples, optical properties of the light emission units (for example, of adjustable lenses associated with the light emission units) and the distal side micro lenses may be dynamically adjusted. For example, one or more lenses may have electrically controlled focal lengths (for example through electrical adjustment of surface curvature and/or refractive index profile) and/or adjustable positions such as physical separations from other components.

In some examples, the AR display system is configured to adjust an intensity of the virtual image layer to visually fuse the virtual image layer and at least one image of a physical object viewed through the AR display system. In some examples, the intensity of light passing through an aperture may be sensed or otherwise determined, for example using an optical sensor located within the pixel structure, and the emission intensity of a light emission unit, if selected for emission, may be adjusted in a manner based on the intensity of incident light. In some examples, an optical sensor may be used to sense an average ambient illumination, and the intensity of a virtual image may be adjusted based in the ambient illumination intensity. An AR display system may be configured to select light emission units, and control a degree of illumination of at least one of the selected light emission units to adjust an intensity of the VR image.

In some examples, an image of the environment is captured, for example using an image sensor, or from sensing incident light intensity (at one or more wavelengths) at each pixel structure. Images of the environment may be transmitted to a computer for processing, for example for object recognition within the image. Data determined from the image may be then included in content data used to determine the display of a VR image superimposed on the viewed image. The computer may be an external device, or included within the VR system.

A virtual image layer may be created based on content data. In some examples, a virtual image layer is produced using light from selected light emission units, for example where the selected light emission units are selected based on the content data.

In some examples, content data are provided by an external data resource, such as a computer. Content data may be retrieved from an external data source using a wired and/or wireless connection, for example over a wireless network. Content data may be stored within an internal memory of an AR display system. In some examples, content data may be provided based on the system position, for example as determined from a GPS (global positioning system). In some examples, content data may be provided based on the orientation of the system, for example based on a compass direction that the system is directed, or an inclination (for example, upward orientation may retrieve astronomical data). In some examples, content data may be used to facilitate identification of objects within the environment, for example based on position. In some examples, content data comprises information data generated by a computer device, such as a personal computer or any device having a computing function, such as a smartphone.

In some examples, an AR display system may further comprise a sensor configured to detect a focal distance of an eye, and adjust the position of at least one component of the pixel structure based on the focal distance. For example, the component may be a lens, for example to adjust a position of the virtual image layer based on the position of the pixel.

In some examples, an AR display system may include, or be in communication with, a computer configured to identify objects within the environment. For example, people, locations (such as buildings), vehicles, animals (such as birds), and other objects may be identified. Light emission units may be used to provide information about objects within the environment, such as identified objects. Information (which may, for example, be presented as a virtual image as, for example, text, images, graphics, or some combination thereof, and the like) may include information ascertained from the appearance of the object, such as an identity (e.g. name of a person, species of animal, dog breed, and the like), location within the field of view (for example, to alert a user to the existence of the object in the environment), tracked motion information (e.g. an object track since detection, and optionally predicted future motion), suspicious behavior (such as apparently inappropriate facial expressions or gesticulations), identity and purchase information related to retail items (for example associated with a person or other object, even if the person or object is not identified, such as desirable electronic devices, clothes, accessories, and the like), and the like. Information may further include information retrieved, e.g. from a computer, based on the identity of the object, such as occupation (e.g. of a person), criminal record, previous encounters (social or otherwise) with the person, previous and current relationships (e.g. friend of friend, and the like), social network relationship, employment relationships, social ratings of an object, purchase information related to an object, and the like. In some examples, a person may select an object in the field of view, and receive information about the object using the AR display device Selection may achieved by one or more of a variety of methods, include pointing to the object (e.g. using finger, tongue, stylus, and the like), eye tracking, eye tracking in combination with another input(such as eye blinking, finger snapping, face tapping, and the like), framing (by fingers or otherwise), or other appropriate method. A virtual image may include, for example, identity data presented as text, positionally aligned with the identified object. A virtual image may present suggestions based on the identity (for example, suggested conversational topics based on a person's identity, or behavioral suggestions based on object characterization (for example, arresting or fleeing a possible criminal, as appropriate). In some examples, graphics may be used (for example bright, primary, and/or flashing colors proximate (e.g. on or around) an object) to draw a user's attention to the object. In some examples, a virtual image may include advertising images, for example including text, images, and/or graphics, for example to display information relating to discounts for an identified object and/or at an identified retail location. In some examples, the virtual image may adapt to a changing environment. For example, on entering a crowded area, identified persons may initially be indicated using graphics, such as color coded information, with further information complexity (e.g. text information) presented subsequently as the number of candidate identified persons is reduced, e.g. by approaching a sub-group or individual in the crowd. In some examples, information on a person may be retrieved and displayed as a virtual image using an identifying element, such as a name tag, business card, drivers' license, passport, and the like. In some examples, information on a person may be retrieved and displayed in a virtual image using audio information, such as a person's spoken identification of themselves. In some examples, a person's apparent identity may be confirmed or rejected by comparing retrieved information (for example retrieved using the person's alleged identity) with the actual appearance of the person.

In some examples, an AR display system may be formed within an optical instrument, such as a contact lens, glasses, head-mounted display, telescope, magnifying glass or other magnifying viewer, binoculars, thermal imaging device, camera, window (such as a vehicle window), and the like. An optical instrument may be provided with or without vision correction features, and in some examples an AR display system may provide vision correction for a user. An AR display system may further include a support assembly configured to support the AR display system on the head of a user, for example comprising one or more of arms that engage the ears, nose pads, straps, adhesive pads, clamps, clips, and the like. An AR display system may also be supported by a separate item worn by a user, such as a head-mounted item, such as a pair of glasses hat, band, and the like. In some examples, a portion of the incident light may be used for imaging the environment, and a computer device used to process the image and to provide content data.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computer device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually, and/or collectively, by a wide range of hardware, software, firmware, or virtually any combination thereof. In one embodiment, several portions of the subject matter described herein may be implemented via Application Specific integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g.,“ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An augmented reality (AR) display system, comprising:
a plurality of pixel structures, wherein each pixel structure comprises:
an object side micro lens disposed on an object side of the pixel structure;
a distal side micro lens disposed on a distal side of the pixel structure;
an aperture plate layer configured to define an aperture, wherein the aperture plate layer is located between the object side micro lens and the distal side micro lens; and
one or more light emission units, wherein the one or more light emission units are located between the object side micro lens and the distal side micro lens,
wherein each pixel structure is configured so that a first light beam incident on the object side micro lens passes through the object side micro lens, the aperture, and the distal side micro lens, and wherein the AR system is operable to produce a virtual image layer based on content data, and
wherein the virtual image layer is produced using light emitted from selected light emission units, wherein the selected light emission units are selected based on the content data.

2. The AR display system of claim 1, wherein the object side micro lens is a convex lens.

3. The AR display system of claim 1, wherein the one or more light emission units are supported by the aperture plate layer.

4. The AR display system of claim 1, wherein the object side micro lens, the distal side micro lens, and the aperture are configured so that the first light beam incident on the object side micro lens emerges from the distal side micro lens along a substantially unchanged direction.

5. The AR display system of claim 1, wherein the one or more light emission units include an electroluminescent light emission unit.

6. The AR display system of claim 1, wherein the content data are provided by an external computer.

7. (canceled)

8. The AR display system of claim 1, wherein the virtual image layer is produced using the selected light emission units and the distal side micro lens.

9. The AR display system of claim 1, wherein the AR display system is configured to adjust an intensity of the virtual image layer to visually fuse the virtual image layer and at least one image of a physical object viewed through the AR display system.

10. The AR display system of claim 1, wherein a direction of light emitted from a selected light emission unit is dependent upon a position of the selected light emission unit.

11. The AR display system of claim 1, further comprising:
a computer device configured to control an intensity of light emission from at least the selected light emission units.

12. (canceled)

13. The AR display system of claim 11, further comprising:
a sensor configured to detect a focal distance of an eye based on the first light beams; and
the computer device is further configured to:
adjust a position of one or more of the pixel structures based on the detected focal distance, and
adjust a position of the virtual image layer based on the adjusted position of the one or more pixel structures.

14. The AR display system of claim 11, further comprising:
an image capture device configured to:
capture the at least one image of the physical object, and
transmit image data corresponding to the at least one image to the computer device to be processed;
wherein the computer device is further configured to produce the at least one virtual image layer using the transmitted image data, to correspond to the at least one image of the physical object.

15. The AR display system of claim 1, wherein the AR display system is formed within a contact lens.

16. The AR display system of claim 1, wherein the AR display system is formed within a head mounted display.

17. The AR display system of claim 1, wherein the virtual image layer is produced to overlay at least one image of a physical object viewed through the AR display system.

18. A method to produce a virtual image layer in an augmented reality (AR) display system that includes a distal side micro lens, an object side micro lens, and a pixel unit, wherein the pixel unit includes a light emission unit and an aperture plate layer that defines an aperture therein, wherein the pixel unit is located between the distal side micro lens and the object side micro lens, the method comprising:
transmitting, by the distal side micro lens together with the object side micro lens and the aperture, first light beams that are emitted or reflected from a physical object;
producing, using the distal side micro lens and at least the pixel unit, the virtual image layer as a display of content provided by an external data source; and
providing the produced virtual image layer concurrently with the transmitting.

19. The method of claim 18, wherein the producing of the virtual image layer comprises:
converging, by the object side micro lens, the first light beams emitted or reflected from the physical object;
allowing, by the aperture plate layer of the pixel unit, the first light beams to pass through the aperture at a center region thereof; and
converging, by the distal side micro lens, the first light beams after the first light beams pass through the aperture, to produce at least one virtual image of the physical object detectable by a user's eye.

20. The method of claim 18, wherein the producing of the virtual image layer comprises:
emitting light from the light emission unit of the pixel unit;
refracting, by the distal side micro lens, the light emitted from the light emission unit to generate a second light beam; and
generating the virtual image layer using the second light beam.

21. The method of claim 20, further comprising:
selecting, by a computer device, the light emission unit;
controlling, by the computer device, a degree of illumination of the selected light emission unit to adjust an intensity of the second light beam; and
fusing the virtual image layer with the at least one image of the physical object based on the adjusted intensity of the second light beam.

22. The method of claim 21, wherein a direction of the second light beam is dependent upon a position of the pixel unit.

23. The method of claim 21, further comprising:
detecting, by a sensor, a focal distance of an eye of a user of the AR display system based on the first light beams; and
adjusting, by the computer device, a position of the virtual image layer by adjusting the detected focal distance and a position of the pixel unit based on the adjusted focal distance.

24. The method of claim 20, further comprising:
capturing, by an image capture device, at least one image of the physical object;
transmitting image data corresponding to the captured at least one image to the image capture device to be processed; and
producing, by the computer device, the virtual image layer using the image data, to correspond to the at least one image of the physical object.

25. A computer-readable medium including executable instructions stored thereon that produce a virtual image layer in an augmented reality (AR) display system that includes a distal side micro lens, an object side micro lens, a pixel unit included between the distal side micro lens and object side micro lens, and a computer device and, which in response to execution, cause one or more processors to perform or control operations comprising:
selecting at least one light emission unit of the pixel unit to emit light;
generating light beams using the light emitted from the selected at least one light emission unit; and
generating a virtual image layer utilizing the light beams, wherein the virtual image layer overlays at least one image of a physical object with a display of content provided by an external data source.

26. The computer-readable medium of claim 25, wherein the generating of the virtual image layer comprises:
producing the virtual image layer at a spatial position corresponding to an intersection point of reverse extension lines of the light beams.

27. The computer-readable medium of claim 26, wherein the instructions in response to execution, cause the one or more processors to perform or control operations further comprising:
controlling, by the computer device, a degree of illumination of the selected at least one light emission unit;
adjusting an intensity of the light beams based on the degree of illumination as controlled; and
fusing the virtual image layer with the at least one image of the physical object based on the intensity of the second light beams as adjusted.

28. An augmented reality (AR) display system, comprising:
a first array of lenses;
a second array of lenses;
an aperture plate layer that defines an array of apertures, wherein the aperture plate layer is located between the first array of lenses and the second array of lenses;
light emission units, supported by the aperture plate layer, wherein the light emission units are located between the between the first array of lenses and the second array of lenses; and
a controller, configured to select and illuminate light emission units based on received content data,
wherein the system is configured so that light incident on the first array of lenses passes through the first array of lenses, the array of apertures, and then through the second array of lenses, and
wherein illumination from the selected light emission units passes through the second array of micro lenses without passing through the array of apertures.

29. (canceled)

30. The AR display system of claim 28,
wherein each lens of the first array of lenses is configured to focus a portion of the incident light on an aperture of the array of apertures; and
wherein each light emission unit is configured to direct illumination through a single lens of the second array of lenses.

31. (canceled)

32. The AR display system of claim 28, wherein the system is configured so that illumination from the selected light emission units forms a virtual image layer as viewed through the second array of lenses.

33. (canceled)

34. The AR display system of claim 28, wherein the first and second arrays of lenses each comprise a planar two-dimensional array of converging micro lenses.
